(19) United States
(12) Patent Application Publication
(10) Pub. No.: US 2012/0180306 A1
(43) Pub. Date: Jul. 19, 2012

(54) Automobile key fob cover and method of assembly thereof

(76) Inventor: Alexander Zatsorenko, Melrose Park, IL (US)

(21) Appl. No.: 12/930,809

(22) Filed: Jan. 18, 2011

(51) Int. Cl. B23P 6/00

(52) U.S. Cl. 29/592.1

(57) ABSTRACT

A preferred embodiment of the invention includes a method for replacing the cover of an electronic key fob used for remote keyless access to an automobile that was damaged due to normal wear-and-tear on the cover or from stress placed on the cover of the key fob at the opening where the key chain is attached. The method of the present invention provides a replacement electronic key fob cover of similar or different design and in the original or different color.

### FIELD OF THE INVENTION

The present invention relates to a remote keyless automobile ignition and door key fob cover and the method for assembly thereof, and more particularly, the present invention relates to removing a damaged cover for an automobile key fob and assembling a replacement automobile key fob cover with buttons for controlling various functions, such as remotely locking and unlocking the automobile doors, releasing the automobile trunk and starting the engine remotely.

### BACKGROUND OF THE INVENTION

From the time of its inception, over one hundred years ago, the automobile has become one of the most important inventions used by man. It allows an individual to get from and to distant locations quicker and safer than the means of travel that preceded the automobile.

Since the 1960s, the number of automobiles registered for use in the United States has been continuously on the rise, and recent statistics report that over a quarter of a billion automobiles are now registered in the United States. This correlates to almost one vehicle for each man, woman and child in the United States.

Often the automobile is used to transport valuable items, either for business or for day-to-day activities, and because the automobile has become such an integral part of daily life, quite often, these valuable items are left in the automobile when there is no one there to watch over them.

Although originally the automobile was an open-air vehicle, usually using a hand crank to start the automobile engine, as the automobile has evolved it has become necessary to protect the automobile from being stolen, and to protect the contents of the automobile and the trunk from being stolen. To do so, various types of locks were implemented, such as an ignition lock, a door lock and a trunk lock. Each of these locks required that the individual attempting to enter the automobile or trunk or attempting to start the engine, use a special key to gain access to the inside of the automobile and start the car.

Of course, using a key to unlock the automobile door can be difficult, especially in inclement weather such as rain, cold or snow, when the keyhole on an automobile door lock can freeze. Freezing temperatures, ice, snow and rain can make it difficult or impossible to insert the key into the lock and open the door.

Over time, and with the advent of electronics and communications, electronic key fobs were developed and are now used for activating such things as remote keyless entry systems on automobiles. These electronic key fobs allow an individual to unlock or open an automobile door or trunk, and start the automobile engine, remotely, simply by depressing a button on the electronic key fob.

Early electric key fobs used infrared (IR) technology, requiring a clear line-of-sight to function, and could be copied using a programmable remote control. Newer electronic key fobs utilize various authentication technologies and radio frequency (RF), diminishing the possibility of being copied and obviating the line-of-sight requirement.

The electronic automobile key fob (referred to herein as “electronic key fob” or “key fob”) is an electronic device that can be attached to an automobile key, either by a chain, or can be integrated therewith such that the keyed portion of the key protrudes from the key fob cover portion. With these configurations, the user can more easily gain access to the automobile or trunk, or start the automobile engine using the key fob.

Further, each automobile has a unique code for opening the door, trunk or starting the engine. These different codes insure that one individual cannot open the door of another individual's automobile, even if the automobiles are similar makes, models and years.

The key fob has a cover portion which is usually made of a black plastic material that houses or encloses the electronics for transmitting a signal and communicating with the particular automobile. The key fob cover portion includes spaces for a number of switches or buttons, also usually black in color, on one or both sides. These buttons allow the user to open the door or trunk, or in some cases, start the engine of the automobile automatically from a distance. Further, by depressing certain buttons, the automobile can be programmed to receive the signal from the electronics in the key fob and blink the headlights or tail lights, sound the horn, or send out a panic signal, among other things.

Since automobile key fobs are relatively small, they can get lost or become difficult to find. Most key fobs (similar to automobile keys themselves) are designed and configured with an attachment ear, hole or opening in the cover that allows the user to easily attach a key chain or other device to prevent from losing the key.

An individual can place a key chain through the opening in the cover making the key fob relatively larger (with the key chain attached) and easier to locate. For ease of use, these openings are usually placed near one of the corners of the key fob cover or at the top. This insures that the key chain will not interfere with the functions of the key fob buttons. The engine ignition key can then be attached to the key fob (if it is not integrated therewith).

However, in use, the individual usually reaches for the key fob by grabbing the key chain, which places stress on the opening of the key fob cover where the key chain is attached. Since the key fob cover is made of plastic and the opening is at one of the corners of the key fob cover, the probability that the opening will wear out and become broken increases over time.

Although replacing a standard automobile ignition key can be done inexpensively, the same is not true for replacing a key fob. When replacing a broken or worn out key fob cover, the internal electronics are also replaced. Since each car has a different code for opening the doors, etc., replacement of a particular key fob must usually be done by the particular automobile dealer and can become quite expensive. In some cases, replacing a key fob can cost hundreds of dollars even though it is only the plastic cover that needs replacing.

Quite often, when the attachment ear or opening on a key fob cover wears out or becomes damaged, and the opening of the key fob cover can no longer hold the key chain, the electronics in the key fob continue to function well. Users may try to glue or tape the opening to hold the key chain, but these efforts usually fall short and do not look very attractive either way.

For all the above reasons, there is a need for a method for inexpensively replacing the cover of an automobile key fob that allows the user to replace only the cover, leaving the original electronics in place. The replacement cover can use stronger materials than the original cover, be configured with the same or a different design, and provide the user with variations in the color of the cover. The present invention attempts to satisfy these needs.

### SUMMARY OF THE INVENTION

The present invention is a method for replacing the damaged cover of an electronic key fob used for remote keyless access to an automobile. Often, the opening or hole in the key fob cover, which has the primary purpose of holding a key chain, becomes damaged over time due to the stress placed on the cover opening by the key chain. The user must then take the automobile key fob to a dealer and have the key fob replaced, which includes replacement of the internal electronics (generally replacing the entire key fob assembly), at a significant cost.

Instead of absorbing the cost of replacing the entire key fob for a damaged cover, the present invention provides for the replacement of the key fob cover only, leaving the key fob electronics in place. In doing so, the replacement key fob cover can be made from a stronger material to reduce the chance of further damage. Also, the replacement key fob cover can be made using other colors and even different designs.

It is an objective of the present invention to provide a replacement electronic key fob cover for a damaged electronic key fob used for remote keyless entry into an automobile.

It is another objective of the present invention to provide for the replacement of the similar design and color key fob cover that was damaged due to wear-and-tear or from stress placed on the opening of the key fob cover where the key chain is located.

It is another objective of the present invention to provide for the replacement of a damaged key fob cover using a differently colored key fob cover than the original.

It is another objective of the present invention to provide for the replacement of a damaged key fob cover using a differently designed key fob cover than the original.

It is another objective of the present invention to provide for the replacement of a damaged key fob cover and some or all of the electronics necessary for remote keyless entry into an automobile.

While the invention is described herein with relation to certain embodiments and applications, those with skill in this art will recognize changes, modifications, alterations and the like which still come within the spirit of the inventive concept, and such are intended to be included within the scope of the invention, as expressed in the drawings, description and claims disclosed herein.

### DESCRIPTION OF THE FIGURES

The invention can be better understood by reading the following detailed description of certain preferred embodiments, reference being made to the accompanying drawings in which:

FIG. 1 is a picture of an automobile key in accordance with the prior art;

FIG. 2 is a picture of an automobile key fob in accordance with the prior art;

FIG. 3 is a picture of a replacement automobile key fob cover prior to installation according to one embodiment of the present invention;

FIG. 4 is a picture of replacement buttons for an automobile key fob cover prior to installation according to one embodiment of the present invention; and

FIG. 5 is a picture of a replacement automobile key fob cover after installation according to one embodiment of the present invention.

### DETAILED DESCRIPTION

The present invention is a method for replacing the damaged cover of an electronic key fob used for remote access to an automobile. The method of the present invention provides for a replacement cover for an electronic key fob that may have been damaged due to wear-and-tear from daily use or broken when dropped or when some other accident occurred. In the preferred embodiment of the present invention, the electronics of the device have not been damaged, only the cover of the device has been damaged.

The method of the present invention include removing the damaged cover from the automobile key fob and replacing it with an undamaged or replacement cover that will allow for the same keyless functionality as the original key fob. That functionality may include unlocking the automobile door or doors, unlocking the automobile trunk, providing assistance in locating the automobile (such as turning the lights of the automobile on and off or sounding the horn), starting the engine, and/or sounding an alarm, among other functionalities.

Additionally, the present invention provides for the replacing the key fob cover that was damaged with a different color cover or with a differently designed cover or both a different design and a different color. In an alternative embodiment, the method of the present invention provides for the replacement of a damaged key fob cover and some or all of the electronics necessary for the remote keyless functionality described herein.

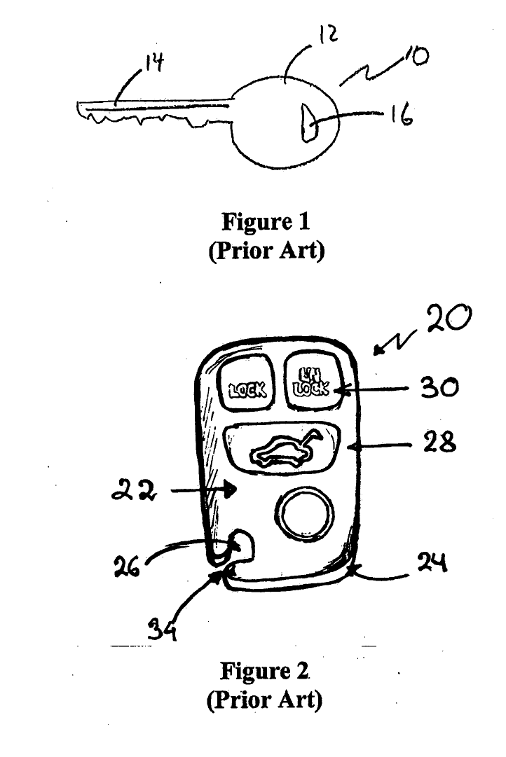

FIG. 1 shows a picture of an automobile key 10 as understood by one having ordinary skill in the art. The automobile key 10 is usually made throughout of steel or another metal for strength and is configured with a head portion 12 and a keyed portion 14. The key 10 also has a hole or opening 16 in the head portion 12 such that a key chain (not shown) can be threaded through the opening 16. Usually, the key chain is larger than the key, and once threaded through the hole 16, the user can more easily locate the key chain and thus the key, for example, in the bottom of a purse or briefcase.

As automobiles and thus automobile keys became more complicated, keys were developed that incorporated electronics into the key itself. Since the keyed portion continued to be necessary to manually open an automobile door or start the automobile engine, the head portion was used to integrate the electronics necessary to provide remote keyless access to the automobile. In many cases, a separate fob was created that did not integrate the keyed portion 14 into the key fob. Both of these embodiments are subject to the present invention although the latter is discussed in detail herein.

FIG. 2 shows a picture of an automobile key fob 20 containing remote keyless electronics (not shown) inside the key fob. In this embodiment, the remote keyless electronics are accessed through the front portion 22 of the key fob 20; however, the electronics could be accessed through the back portion 24 of the key fob 20. Also shown, is the hole or opening 26 in the front portion 22 of the key fob 20. Similar to the standard metal key 10 of FIG. 1, the opening 26 in the key fob 20 provides a location where a key chain can be attached to the key 20.

The key fob 20 also contains a number of buttons 28, 30, 32 located in the front portion 22 of the key fob 20. The buttons 28, 30, 32 are an example of buttons on a key fob 20; there may be less, more or the same amount. Further, the some or all of the buttons 28, 30, 32 may be located on one or both sides 22, 24 of the key fob 20. These buttons 28, 30, 32 provide access to the remote keyless functions. For example, depressing button 28 may remotely lock the doors of the automobile, while depressing button 30 may remotely unlatch the automobile trunk. In another example, button 32 may be a panic button, and depressing the button 32 on the key fob 20 may sound the horn to bring attention to the area.

As described herein, through normal wear-and-tear, or through an accident, the cover to the key fob 20 may become damaged. In many instances, a portion 34 of the hole or opening 26 may break off and the opening 26 will no longer be able to retain a key chain.

In this event, an undamaged or new cover can be used to replace the damaged cover to provide the same functionality while also providing, for example, an undamaged hole or opening to retain the key chain. Further, the replacement cover can be manufactured in numerous colors and different designs and still provide the same functionality.

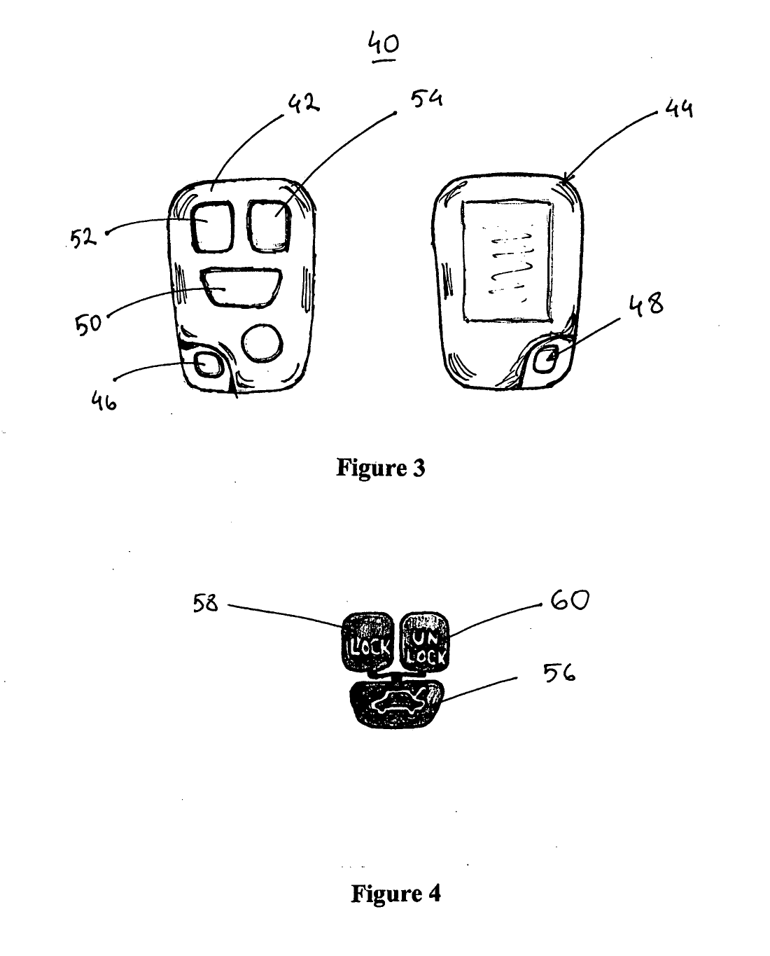

FIGS. 3A and 3B show a picture of both sides of a replacement key fob cover 40 of the preferred embodiment of the present invention. The cover 40 contains a front side cover 42 and a back side cover 44. The front side cover 42 has an opening or hole 46 intended to allow the key fob cover 40 to attach to a key chain or the like, when assembled in accordance with the present invention. Likewise, the key fob back cover 44 has an associated hole or opening 48, such that when the front side cover 42 and the back side cover 44 are assembled together, the holes 46, 48 will line up creating a feed-through.

The front side cover 42 also contains additional holes 50, 52, 54 that do not have associated holes on the back side cover 44. These holes 50, 52, 54 will allow the user access to the buttons 56, 58, 60 (see FIG. 4) that provide the keyless functionality described herein. Once the front side cover 42 and back side cover 44 are assembled together (with the buttons 56, 58, 60 inserted), the user will be able to depress each of these buttons 56, 58, 60 through the holes 50, 52, 54 to transmit the necessary signals to the electronics located in the automobile to provide the function being requested.

FIG. 4 shows a picture of the buttons 56, 58, 60 that are assembled into the key fob 40 when the front side cover 42 and back side cover 44 are attached to each other. Once assembled, the openings 50, 52, 54 will correspond to the buttons 56, 58, 60, respectively. Thus for example, by depressing button 56 through hole 50, the automobile doors will remotely lock.

The method of the present invention includes disassembling the damaged key fob cover 20 (FIG. 2) and leaving the electronics in place. The buttons 56, 58, 60 are placed into the holes 50, 52, 54 on the front side cover 42 and the damaged key fob cover 20 (with the damaged key fob cover removed) is placed into the front side cover 42. The back side cover 44 is then lined up with the front side cover 42 so that the electronics of the device are completely enclosed. The front side cover 42 and back side cover 44 are then snapped together to make a tight fit.

Other methods of assembling the front side cover 42 and back side cover 44 include using glue, screws or any other means to attach and securely hold the two covers 42, 44 together. Further, in replacing the covers 42, 44, the present invention also contemplates replacing some or all of the electronics, if there has been damage to the electronics.

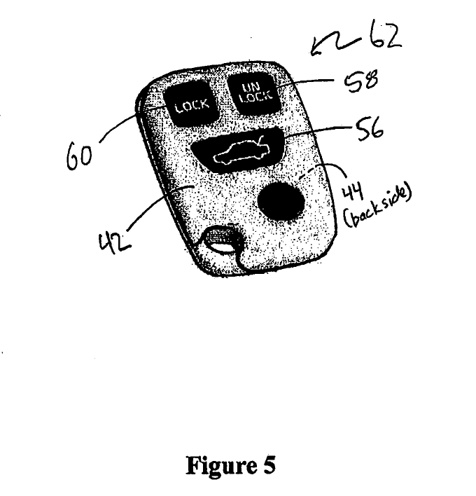

FIG. 5 shows the electronic key fob 62 after being assembled in accordance with the methods of the present invention. The front side cover 42 is displayed in the figure, while the back side cover 44 is hidden from view. Each of the buttons 56, 58, 60 are shown through the respective holes 50, 52, 54, and the key chain hole 46 is shown as passing through to the other side (hole 48—not shown). Now the replacement cover 40 of the key fob 62 can accept and hold a key chain.

Of course, the damaged key fob is not limited to a damaged key chain hole and the present invention can be used to replace the key fob cover for any damage to the key fob.

Although the present invention has been described in considerable detail with reference to certain preferred versions thereof, other versions are possible. Therefore, the spirit and scope of the appended claims should not be limited to the description of the preferred embodiment described herein.

What is claimed is:

1. A method for replacing a damaged key fob cover comprising the steps of:
removing the damaged key fob cover;
taking away the buttons from the damaged key fob;
installing new buttons for accessing the keyless electronics;
locating the key fob into the replacement front cover;
placing the replacement back cover in the proper position;
assembling the front and back covers to each other, thereby enclosing the keyless electronics.

2. The method for replacing a damaged key fob cover of claim 1, wherein the replacement front cover contains a hole where a key chain can be attached.

3. The method for replacing a damaged key fob cover of claim 1, wherein the replacement back cover contains a hole where a key chain can be attached.

4. The method for replacing a damaged key fob cover of claim 1, wherein the assembling the front and back covers to each other, thereby enclosing the keyless electronics comprises snapping the front cover and back cover together.

5. The method for replacing a damaged key fob cover of claim 1, wherein the assembling the front and back covers to each other, thereby enclosing the keyless electronics comprises screwing the front cover and back cover together.
